(19) United States
(12) Patent Application Publication
(10) Pub. No.: US 2011/0298214 A1
(43) Pub. Date: Dec. 8, 2011

(54) Vertical Axis Fluid Turbine

(76) Inventor: Antone R. Thompson, Cedar City, UT (US)

(21) Appl. No.: 13/149,305

(22) Filed: May 31, 2011

Related U.S. Application Data
(60) Provisional application No. 61/350,763, filed on Jun. 2, 2010.

(51) Int. Cl. F04D 25/16; H02P 9/04; F03D 9/00

(52) U.S. Cl. 290/44; 415/60; 290/55

(57) ABSTRACT

A fluid turbine, comprising an inner shaft comprising a first number of concave vanes coupled thereto, the first number of concave vanes forming a number of rows of vanes, and an outer shaft, coaxial to the inner shaft, comprising a second number of concave vanes coupled thereto, the second number of concave vanes forming a number of rows of vanes in which adjacent rows of vanes alternate between the first number of vanes and the second number of vanes, in which the first number of vanes rotate axially in a first direction, in which the second number of vanes rotate axially in a second direction, and in which the concave surface of the first and second number of concave vanes define a fluid gathering surface.

### RELATED DOCUMENTS

The present application claims benefit under 35 U.S.C. §119(e) of U.S. Provisional Application No. 61/350,763, filed Jun. 2, 2010. This application is herein incorporated by reference in its entirety.

### BACKGROUND

The search for more efficient forms of energy has recently surged due, at least in part, to environmental concerns and increasing costs of energy. As an alternative to fossil fuel-based energy sources, energy derived from fluid has been seen as a viable solution to alleviate these concerns. Through the use of fluid turbines, energy may be harvested and used to power homes, automobiles, and generally supplement or replace current forms of energy generation.

A vertical axis fluid turbine is one method of generating energy from fluid. Vertical axis fluid turbines are a type of fluid turbine that includes a central shaft arranged vertically with respect to the ground. The vertical shaft supports a plurality of vanes. These vanes arrayed around the shaft, can rotate about the shaft and are aligned roughly perpendicular to the fluid flow such that the maximum amount of surface area on each vane is pushed by the fluid.

The efficiency of vertical axis fluid turbines is limited, due to the power produced by any one fluid-gathering vane being offset by the drag produced by any other oppositely-oriented vane. In addition, since the surface area of the vanes exposed to the fluid flow varies as the turbine rotates, the torque transmitted to the shaft also varies throughout the revolution of the vanes.

Further, the maximum velocity of the vanes of a vertical axis fluid turbine is substantially equal or less than the velocity of the fluid flow. This type of turbine can produce high torque and can be useful for pumping water and other similar tasks.

### BRIEF DESCRIPTION OF THE DRAWINGS

The accompanying drawings illustrate various examples of the principles described herein and are a part of the specification. The illustrated examples, however, do not limit the scope of the claims.

FIG. 1 is a perspective view of a vertical axis fluid turbine incorporating an electric power generator according to one example of the principles described herein.

FIG. 2 is a top view of a vertical axis fluid turbine according to one example of the principles described herein.

FIG. 3 is a cross-sectional front view of a portion of the vertical axis fluid turbine of FIG. 1 according to one example of the principles described herein.

FIG. 4 is a cross-sectional front view of a portion of the connecting hubs and center shafts of the vertical axis fluid turbine of FIG. 1 according to one example of the principles described herein.

FIG. 5 is a cross-sectional front view of a vertical axis fluid turbine having quarter-sphere end portions attached to the vanes, in which the vanes are separated from the shafts according to one example of the principles described herein.

FIG. 6 is a front view of an electric power generator of the fluid turbine of FIG. 5 according to one example of the principles described herein.

FIG. 7 is a diagram of the fluid flow force enhancement produced by the turbine of FIG. 1 according to one example of the principles described herein.

FIG. 8 is a graph of the torque oscillations produced by the turbine of FIG. 1 according to one example of the principles described herein.

FIG. 9 is an axonometric side view of a number of vanes according to one example of the principles described herein.

Throughout the drawings, identical reference numbers designate similar, but not necessarily identical, elements.

### DETAILED DESCRIPTION

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one embodiment, but not necessarily in other examples. The various instances of the phrase “in one example” or similar phrases in various places in the specification are not necessarily all referring to the same example.

Throughout this specification and in the appended claims, the term “fluid” refers to any substance that is capable of flowing and that changes shape at a steady rate when acted upon by a force tending to change its shape. In one example within the present specification, a fluid may be a flow of gases such as wind. In another example within the present specification, a fluid may be water. In yet another example, a fluid may be compressible or non-compressible substance.

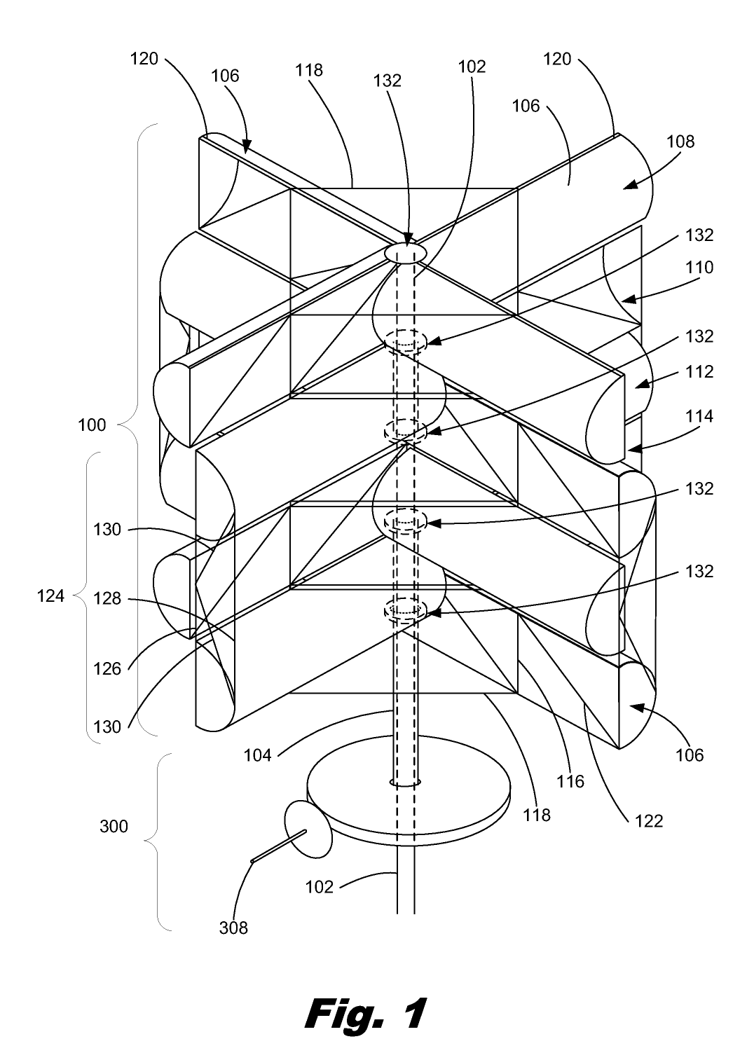

Turning now to the figures, FIG. 1 shows a perspective view of a vertical axis fluid turbine (100) incorporating an electric power transmission (300) according to one example of the principles described herein. The vertical axis fluid turbine (100) includes an inner shaft (102) and an outer shaft (104) that rotate about a common axis. The inner (102) and outer shafts (104) are oriented vertically with respect to the ground and together are coupled to sixteen concave vanes (106). Fluid flow impinging on the vanes (106) causes the shafts (102, 104) to rotate about a common vertical axis. Although FIG. 1 shows sixteen concave vanes (106) being coupled to the inner (102) and outer shafts (104), more or less vanes may be coupled to the two shafts (102, 104). The two shafts (102, 104) may be coupled to the concave vanes (106) with connecting hubs (132) in a manner that will be more fully described below.

The vanes (106) may be made of any thin-walled concave structure. In one example, the vanes (106) are in the approximate shape of a half-cylinder. In another example, the vanes (106) may be in the approximate shape of a triangular prism. This triangular prism shape may reduce the drag force on a particular vane and thus increase the efficiency of the fluid turbine (100). Although FIG. 1 depicts the vanes (106) as half-cylinder vanes, the vanes (106) may be curved along the length of the vane (106) to form a concave structure that is curved along the vertical as well as the horizontal axes. Another example may include vanes (106) that are in the approximate shape of a chevron. Other examples encompass vane (106) configurations of various aspect ratios defined by the height, width, and length of the vanes (106).

The concave surface in each of the individual vanes (106) defines a fluid gathering surface. With the fluid gathering surface, the fluid drags or forces the vane (106) to rotate about the axes of the inner (102) and outer shafts (104). A number of vanes (106) may be arranged into one or more rows (108, 110, 112, 114) with each gathering surface facing a back side or convex surface of a horizontally neighboring vane (106). The example in FIG. 1 shows four vanes (106) for each row of vanes (106). However, more or less vanes (106) may be included in a single row with one or more rows of vanes (106) coupled to the inner (102) and outer shafts (104).

In one example, adjacent rows of vanes (106) include vanes (106) that rotate in opposite directions wherein the gathering surfaces of each row are facing opposite directions. For example, the first row (108) and the third row (112) rotate in a clockwise direction when viewed from the top of the vertical axis fluid turbine (100), while the second row (110) and the fourth row (114) rotate in the counterclockwise direction when also viewed from the top of the vertical axis fluid turbine (100). To facilitate the counter rotation of the rows (108, 110, 112, 114) of vanes (106), the inner shaft (102) and the outer shaft (104) may be held in position using bearings that allow the shafts to rotate independently and counter to one another.

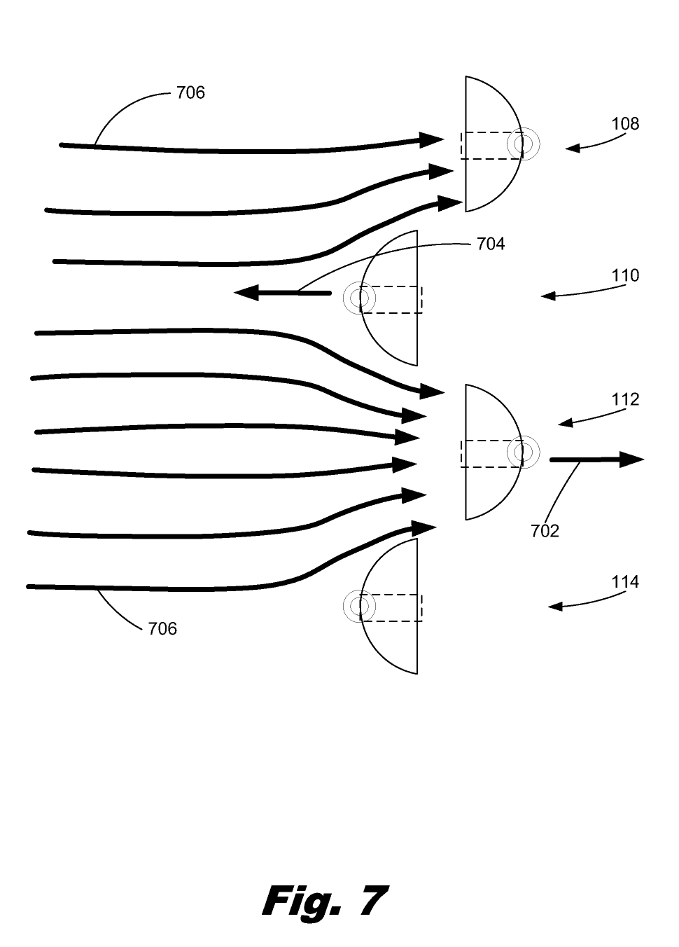

The above arrangement of rows (108, 110, 112, 114) provides increased efficiency as fluid flowing around the non-gathering or convex side of each vane (106) within a row (108, 110, 112, 114) of vanes (106) is funneled into the fluid gathering side of vanes (106) on an adjacent row (108, 110, 112, 114) as depicted in FIG. 7. This increases the amount and speed of the fluid entering the fluid gathering side of the vane (106) thereby increasing the torque transmitted to the shafts (102, 104). Consequently, this greatly increases the efficiency of the fluid turbine (100). The increase in amount and speed of fluid entering the gathering side of the vane (106) also decreases the torque required to initiate rotation of the fluid turbine (100).

In one example the gathering surface of some or all of the vanes (106) are positioned substantially perpendicular to the fluid flow. In another example, some or all of the vanes (106) have a gathering surface that is skewed relative to the fluid flow. Skewing of the vanes (106) increases the pressure exerted on the vane (106) and further increases the lift force on the vane (106) thereby reducing the drag forces exerted on the non-fluid gathering side of the vane (106). In another example, the vanes (106) are substantially perpendicular to the shafts (102, 104). In yet another example, the fluid turbine (100) has vanes (106) that are not substantially perpendicular to the shafts (102, 104).

To take advantage of the power produced by the fluid turbine (100), the shafts (102, 104) may be coupled to an electric power transmission (300) which generates electricity. In another example, the shafts (102, 104) may be coupled to a pumping system to, for example, provide access to subterranean water sources.

The vanes (106) may be divided into sections by any number of vane dividers (116) that may be positioned at any point along the length of a vane (106). Each vane (106) may further include any number of vane braces (118). The vane braces (118) may be coupled at one end to a particular vane (106) of a particular row and coupled at the other end to another vane (106) in the same row. The vane braces (118) therefore add an additional support structure between the individual vanes (106) of each row (108, 110, 112, 114) of vanes (106). In another example, the vanes (106) each may be supported by a cantilever. In this example, a single beam may carry the weight of each vane.

Still further, each vane (106) may include a horizontal support (120) which is positioned along the length of a vane (106) to stabilize the vane during operation. The horizontal support (120) may be coupled at one end to the shafts (102, 104) through various connecting hubs (132) in a manner more fully described below. In one example, the horizontal support (120) may be placed along a top longitudinal edge of a vane (106), a bottom longitudinal edge of a vane (106), or both.

Even further, each vane (106) may include an angled support (122) which is coupled at one end to a corner of the gathering surface of a vane (106), and coupled at the other end to an opposite corner of the gathering surface of the vane (106). Any number of angled supports (122) may be positioned within a vane (106). In one example, each vane (106) may comprise an angled support (122) that is coupled at one end to a corner of the gathering surface of a vane (106) and coupled at the other end to an opposite corner of a vane divider (116).

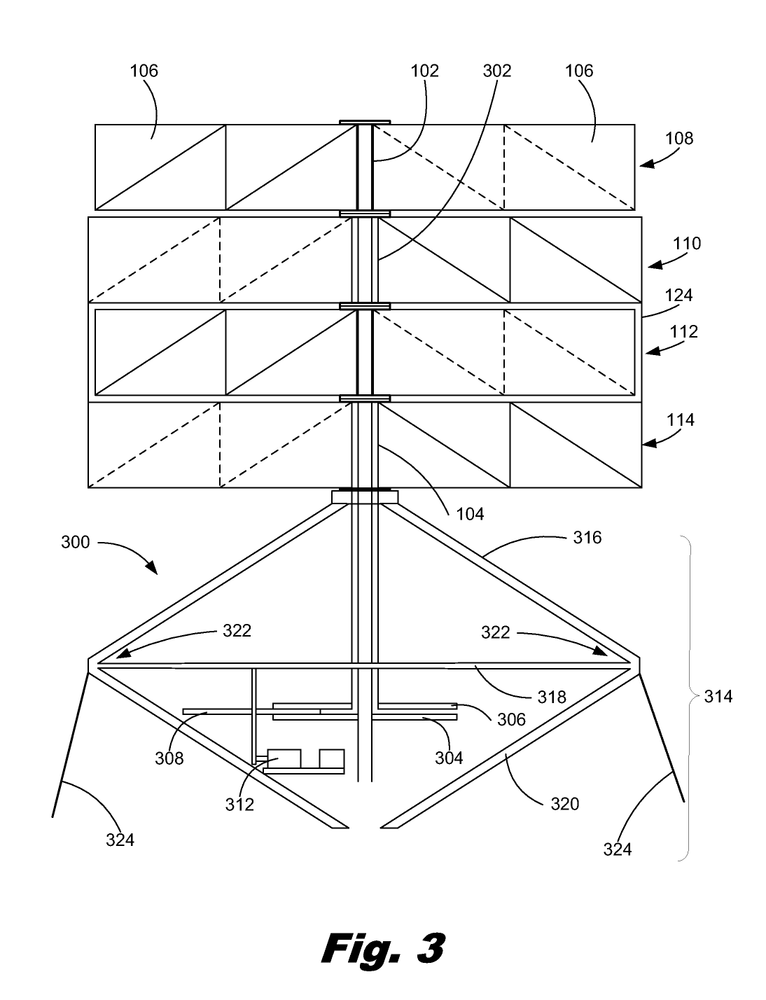

The vanes (106) of each of the alternating rows (108, 110, 112, 114) may be secured to one another through a truss assembly (124). The truss assembly (124) may include a leading edge support (126) pertaining to the gathering side of a vane (106), a trailing edge support (128) pertaining to the trailing edge of a vane, and any number of support ties (130). In one example, the leading edge support (126) and the trailing edge support (128) may be aligned substantially parallel to one another. In this example, the vanes (106) comprising adjacent rows (110, 112) may be offset from one another (as illustrated in FIG. 3) to allow for dual rotation.

When configured in the fashion described above, any number of rows (108, 110, 112, 114) of vanes (106) may be utilized in the fluid turbine (100) wherein alternating rows (108, 110, 112, 114) are oriented to face opposite directions. For example, a fluid turbine (100) that includes six rows (108, 110, 112, 114) of vanes (106) may be configured such that the first row (the upper most row) and every other row below the first row are coupled to the inner shaft (102). In this same example, the second row (110) and every other row below the second row may be coupled either directly or indirectly to the outer shaft (104) through the use of the truss assembly (124) described above.

In one example, the individual vanes (106) may comprise a braking system which prevents the vanes (106) from gathering a fluid into the fluid gathering surface. In this example, a side of the vane (106) may be allowed to disengage with the first or second shaft (102, 104) thereby allowing at least a portion of the fluid to pass by the vane (106) without being gathered into the fluid gathering surface. The braking system may allow the portion of the vane (106) to disengage when a fluid speed exceeds a threshold amount. In another example, the portion of the vane (106) may disengage from the shafts (102, 104) when a threshold force is applied to the vane (106). In both examples of the braking system described above, a spring may be coupled to the side of the vane (106) so that when the fluid speed or load placed on the vane (106) drops below the threshold amount, the vanes may be reengaged with the shafts (102, 104).

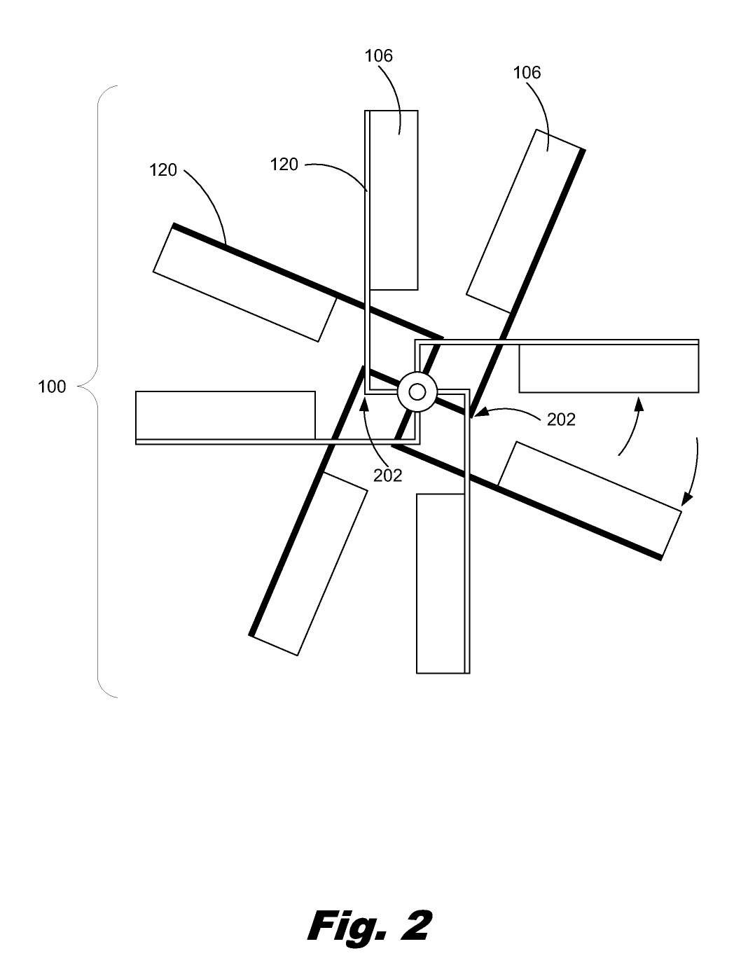

FIG. 2 is a top view of a vertical axis fluid turbine (100) according to one example of the principles described herein. One example of the fluid turbine (100) may include horizontal supports (120) which include an angled bend (202) at a point along their length. In this example more fluid flow can be directed through the center of the fluid turbine and immediately adjacent to the shafts (FIG. 1, 102, 104). This prevents a flow of fluid from treating the entire fluid turbine (100) as an object to flow around and instead allows at least a portion of the fluid to go in between the vanes (106). Consequently, this may increase the torque produced by the fluid turbine.

Furthermore, the horizontal supports (120) may be positioned along the length of a vane (FIG. 1, 106) to stabilize the vane during operation. In one example, the horizontal support (120) may be placed along the back longitudinal surface of a vane (FIG. 1, 106).

FIG. 3 is a cross-sectional front view of a portion of the vertical axis fluid turbine of FIG. 1 according to one example of the principles described herein. Alternating rows of vanes (106) may be coupled to similar shafts (102, 104). For example a first row of vanes (108) and a third row of vanes (112) may be coupled to the inner shaft (102). In this example the first row (108) and the third row (112) may rotate in a similar direction.

In another example, the fourth row (114) may be directly coupled to the outer shaft (104). The second row (110) may be indirectly coupled to the outer shaft (104) through the truss assembly (124) mentioned above. The truss assembly (124) couples the second row (110) to the fourth row (114) allowing the rotational energy of the second row (110) to be directed through the fourth row (114) of vanes (FIG. 1, 106) and into the outer shaft (104). In this example the second row (110) may be aligned along a similar vertical axis as the inner and outer shafts (102, 104) through a coupling sleeve (302). This coupling sleeve (302) may be allowed to rotate axially in a direction distinct from the inner shaft (102). Accordingly, the coupling sleeve (302) is secured to the inner shaft (102) using bearings that permit the coupling sleeve (302) and the inner shaft (102) to rotate independently and counter to one another.

In one example, the fluid turbine may be coupled to an electric power transmission (300) through an energy conversion unit. The outer and inner shafts (102, 104) may each have a flywheel (304, 306) coupled to them. These flywheels (304, 306) may drive the electric power generator (300). Consequently, the electric power transmission (300) converts the energy of the flywheels (304, 306) into electrical energy.

More specifically, in one example, the inner shaft (102) may be coupled at one end to a number of rows (108, 112) of vanes (106) that rotate in a first direction and coupled at the other end to a first flywheel (304). The first flywheel (304) may be rigidly coupled to the inner shaft (102) such that it rotates in the same direction as the inner shaft (102). Similarly, the outer shaft (104) may be coupled, directly or indirectly, at one end to a number of rows (110, 114) of vanes (FIG. 1, 106) that rotate in a second direction and coupled at the other end to a second flywheel (306). The second flywheel (306) may also be rigidly coupled to the outer shaft (104) such that it rotates in the same direction as the outer shaft (104). As a result, the first flywheel (304) and the second flywheel (306) rotate independently and counter to one another. A connecting shaft (308) may be coupled to and positioned between the first flywheel (304) and the second flywheel (306) such that the counter rotation of the flywheels (304, 306) causes the connecting shaft (308) to rotate about its longitudinal axis in only one direction. The connecting shaft (308) may then be coupled to any number of gears (310) that drive a generator (312). Consequently the generator (312) generates electrical power.

In another example the fluid turbine may be coupled to the generator (312) through a direct drive system. A direct drive system increases the power transmission from the shafts to the generator. In another example a gate diode may be used to regulate the rotation of the shafts based on the amount of torque transmitted to the generator in order to maximize the torque transmitted to the generator. Specifically, an electric circuit gate diode may be coupled to the shafts such that a voltage or current can be measured and compared to an subsequent voltage or current measurement. By using the electric circuit gate diode, the load placed on the shaft may be increased or decreased to maximize the electric power produced.

The fluid turbine (100) and electric power transmission (300) may further be coupled to a support framework (314) which prevents the fluid turbine (100) and power generator (300) from falling over. In one example, the support framework (314) may comprise any number of upper frame members (316), horizontal frame members (318), and lower frame members (320). In this example, one end of the frame members (316, 318, 320) may be coupled at a common vertex point (322) and the opposite ends may be coupled to the fluid turbine (100).

The support framework (314) may further include support wires (324) to secure the fluid turbine (100) to a stable surface. The support wires (324) may be coupled at one end to the common vertex point (322) and secured at the other end to the stable surface.

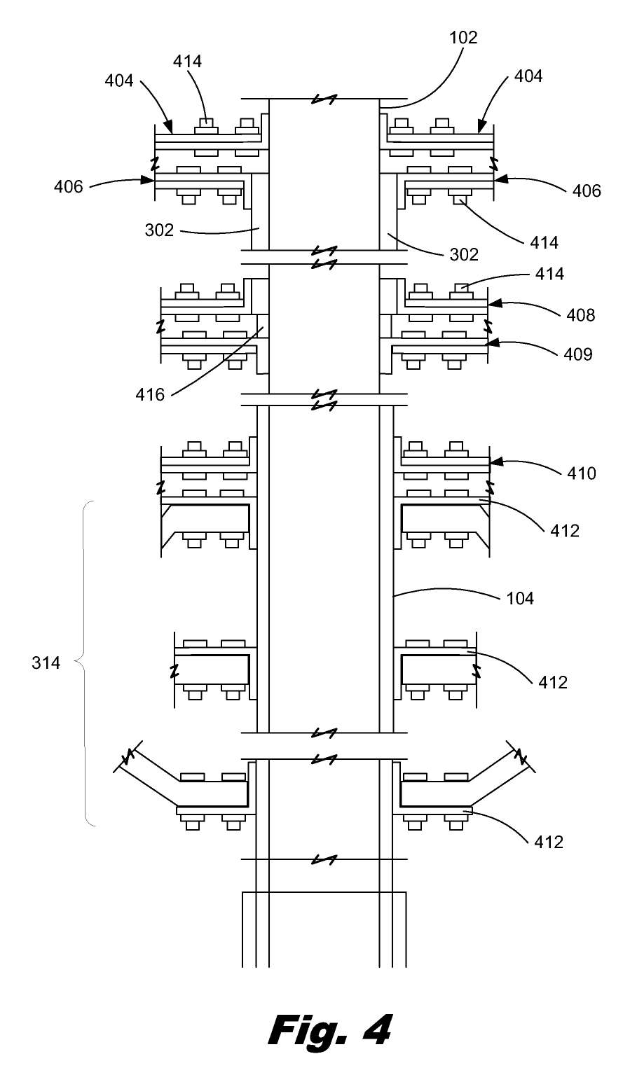

FIG. 4 is a cross-sectional front view of a portion of the connecting hubs and shafts of the vertical axis fluid turbine (FIG. 1, 100) of FIG. 1 according to one example of the principles described herein. As described above, in one example, rows (FIG. 1, 108, 110, 112, 114) of vanes (FIG. 1, 106) may be coupled to the inner shaft (102) and the outer shaft (104). Certain vanes (FIG. 1, 106) may be coupled directly to the shafts (102, 104). For example, the first row (FIG. 1, 108) and the third row (FIG. 1, 112) may be coupled directly to the inner shaft (102) and the fourth row (FIG. 1, 114) may be coupled directly to the outer shaft (104). In another example certain vanes (FIG. 1, 106) may be coupled indirectly to the shafts. For example, the second row (FIG. 1, 110) may be indirectly coupled to the outer shaft (104) through the truss assembly (FIG. 1, 124) to which it is coupled to the fourth row (FIG. 1, 114) which may be directly coupled to the outer shaft (104). In this example, the second row (FIG. 1, 110) may be kept in alignment with the inner shaft (102) through the coupling sleeve (302).

In one example, the vanes (FIG. 1, 106) may be coupled to the corresponding shafts (102, 104) through any number of connecting hubs (402, 404, 406, 408). For example, the first row (FIG. 1, 108) may be coupled to the inner shaft (102) through an upper connecting hub (not pictured) and a lower connecting hub (404). This may be done by using, for example, any number of bolts (414) to secure corresponding horizontal supports (120) to the corresponding connecting hub (404). Similarly, the second row (FIG. 1, 110) may be coupled to the coupling sleeve (302) through an upper connecting hub (406) and a lower connecting hub (408). The second row (FIG. 1, 110) may likewise be coupled using any number of bolts (414). The third row (FIG. 1, 112) may be coupled to the inner shaft (102) through another upper connecting hub (409) and another lower connecting hub (not shown). Even further, in this example, the fourth row (FIG. 1, 114) may be connected directly to the outer shaft (104) through a connecting hub (410) and any number of bolts (414) in the manner described above.

In another example, the support framework (314) may be coupled to the outer shaft (104) through connecting hubs (412) in the manner described above. In this example the connecting hubs (412) are coupled to the outer shaft (104) using bearings that permit the outer shaft (104) to rotate while maintaining the support framework (314) stationary.

Additionally, a number of bearings (416) may be placed in between the number of rows (FIG. 1, 108, 110, 112, 114) of vanes (FIG. 1, 106). The bearings (416) may provide for easier relative motion between the rows (FIG. 1, 108, 110, 112, 114) of vanes (FIG. 1, 106) and may also prevent wear and tear on the parts of the fluid turbine (FIG. 1, 100).

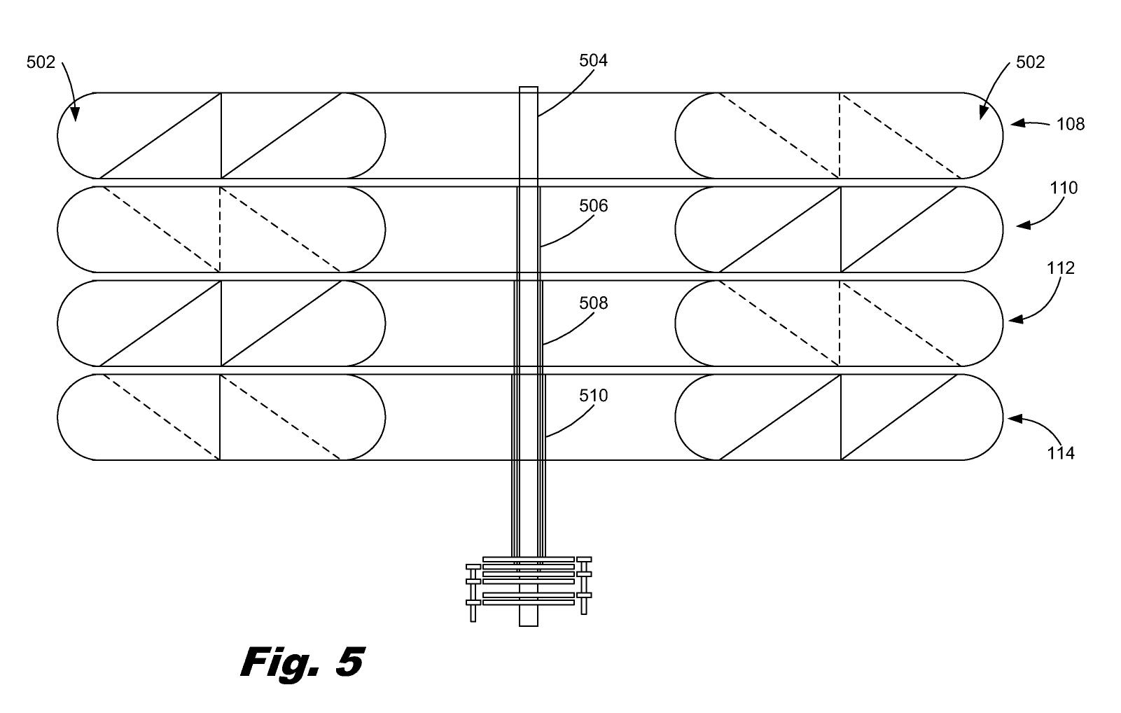

FIG. 5 is a cross-sectional front view of a fluid turbine having quarter-sphere end portions attached to the vanes (FIG. 1, 106) according to another example of the principles described herein. In this example, the fluid turbine (100) may comprise quarter-sphere structures (502) coupled to at least one end of a vane (FIG. 1, 106). The quarter-sphere structures (502) increase the surface area of the gathering surface of the vanes as well as reducing drag on the trailing surface of the vanes (FIG. 1, 106) thereby increasing the torque transmitted to the corresponding shafts.

In another example, distinct rows of the fluid turbine (100) may be coupled to distinct center shafts. For example, the first row (108) may be coupled to a first shaft (504) in the manner consistent with this disclosure. Likewise, other rows may be coupled to corresponding shafts—e.g. the second row (110) may be coupled to a second shaft (506), the third row (112) may be coupled to a third shaft (508), and the fourth row (114) may be coupled to a fourth shaft (510). In this example, with four individual shafts (504, 506, 508, 510) more free movement of the fluid flow is permitted which will consequently increase the torque transmitted to the generator.

In the example shown in FIG. 5, shafts that rotate in a similar direction may be coupled together. For example, the first shaft (504) is coupled to the third shaft (508). As fluid flow impinging on the first row (108) causes the first shaft (504) to rotate, the coupling causes the third shaft (508) to likewise rotate. In this example, the second shaft (506) and the fourth shaft (510) may be likewise coupled.

Various examples of the fluid turbine (100) encompass configurations wherein said vanes (FIG. 1, 106) are positioned at various radial distances from the central shafts. Such examples direct more fluid flow through the center of the fluid turbine, immediately adjacent to the shafts (FIG. 1, 102, 104). As a consequence this too may increase the torque produced by the fluid turbine.

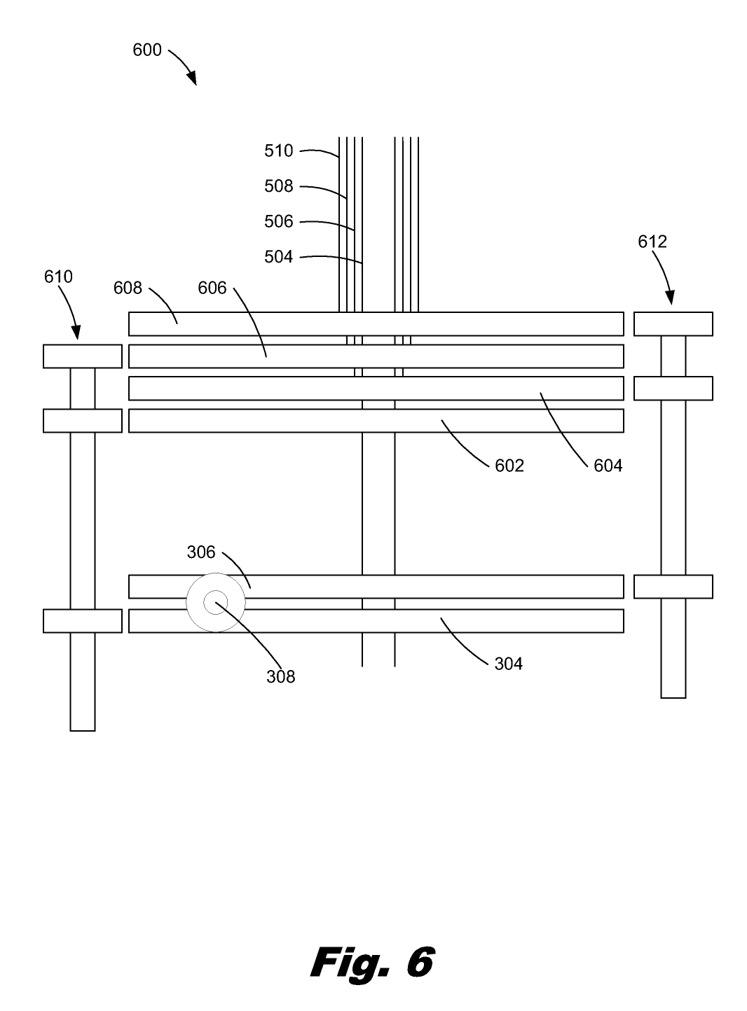

FIG. 6 is a front view of an electric power generator (600) of the fluid turbine of FIG. 5 according to another example of the principles described herein. The power generator (600) may include various driving gears (602, 604, 606, 608) coupled to corresponding shafts (504, 506, 508, 510). For example, a first driving gear (602) may be coupled to the first shaft (504), a second driving gear (604) may be coupled to the second shaft (506), a third driving gear (606) may be coupled to the third shaft (508), and a fourth driving gear (608) may be coupled to the fourth shaft (510).

Driving gears (602, 604, 606, 608) that rotate in a similar direction may be coupled to a corresponding driving shaft (610, 612) which is coupled at one end to the corresponding gears, and coupled at the other end to a corresponding flywheel (304, 306). For example the first driving gear (602) and the third driving gear (606) may be coupled to a first driving shaft (610) such that the rotation of the driving gears (602, 606) causes the first driving shaft (610) to rotate the first flywheel (304). Likewise, the second driving gear (604) and the fourth driving gear (608) may be coupled to a second driving shaft (612) such that the rotation of the driving gears (604, 608) causes the second driving shaft (612) to rotate the second flywheel (306). As a result the first flywheel (304) and the second flywheel (306) may rotate independently and counter to one another. To accomplish this, one of the first and second flywheels (304, 306) may be rigidly connected to the first shaft (504) while the other may rotate freely about the first shaft (504) using, for example, bearings. A connecting shaft (FIG. 3, 308) may similarly be coupled to and positioned between the first flywheel (304) and the second flywheel (306) as described above in connection with FIG. 3. The connecting shaft (FIG. 3, 308) may then be engaged with the first and second flywheels (304, 306) using, for example, a 45 degree gear. The 45 degree gear may engage the side portions of the first and second flywheels (304, 306). The connecting shaft (FIG. 3, 308) may then transfer the energy to any number of gears (FIG. 3, 310) and may then drive an electric power generator (FIG. 3, 312) thereby generating electricity.

In another example, a fluid turbine such as that depicted in FIG. 5 may be coupled to the generator (FIG. 3, 312) through a direct drive system. In another example a gate diode may be used to regulate the rotation of the shafts to maximize the torque transmitted to the generator.

FIG. 7 is a diagram of the fluid flow force enhancement produced by the fluid turbine of FIG. 1 according to one example of the principles described herein. In one example, the first row (108) vanes (106) and the third row (112) vanes (106) may rotate in a first axial direction (702) which is in line with the direction of a fluid flow (706); while the second row (FIG. 1, 110) and the fourth row (114) may rotate in a second axial direction (704) that is against the direction of the fluid flow (706). As the fluid flow (706) passes over the convex surface of the vanes of the second row (110) and the fourth row (114), it is directed into the concave surface of the vanes of the first row (108) and the third row (112). This increase in fluid flow (706) increases the force and speed of the fluid flow (706) on the first row (108) and the third row (112) of vanes.

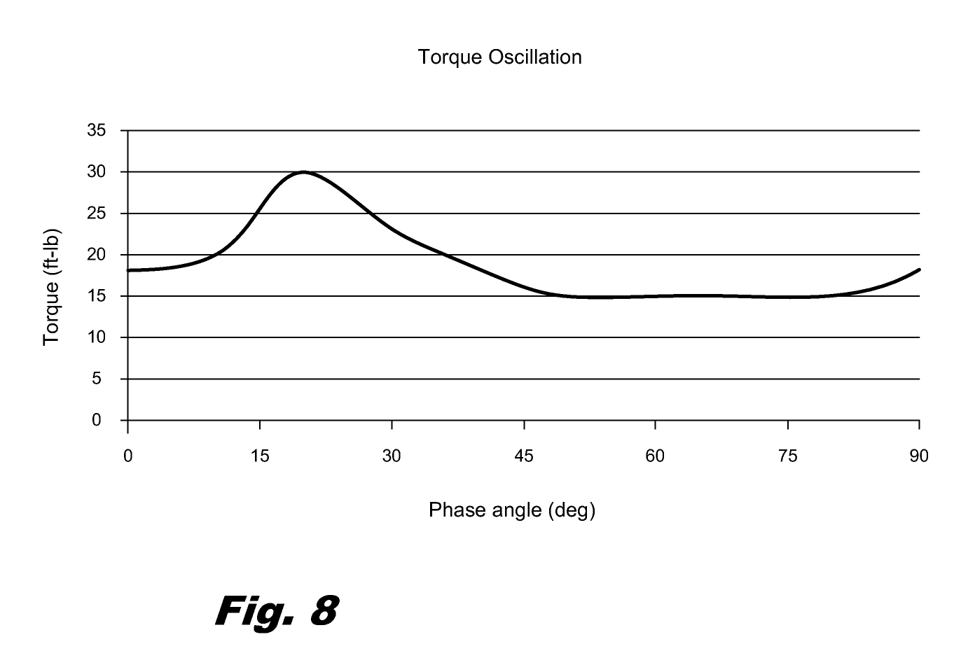

FIG. 8 is a graph of the torque oscillations produced by the fluid turbine of FIG. 1 according to one example of the principles described herein. With one row of vanes, for example the fourth row (FIG. 1, 114), held stationary, an adjacent row, for example the third row (FIG. 1, 112), was allowed to rotate. A measurement was taken of the torque applied to the fourth row of vanes (FIG. 1, 114) throughout the portion of a revolution of the third row (FIG. 1, 112). The term “phase angle” refers to the angle created between a particular vane on one row, for example the fourth row (FIG. 1, 114), and a corresponding vane on an adjacent row, for example the third row (FIG. 1, 112).

As is seen at a phase angle of approximately 22 degrees, the torque applied to the fourth row (FIG. 1, 114) reached an apex significantly greater than the nominal value. Thus indicating that the orientation of the vanes (FIG. 1, 106) of the fluid turbine (FIG. 1, 100) increases the amount of torque that is applied to the electric power transmission (FIG. 3, 300).

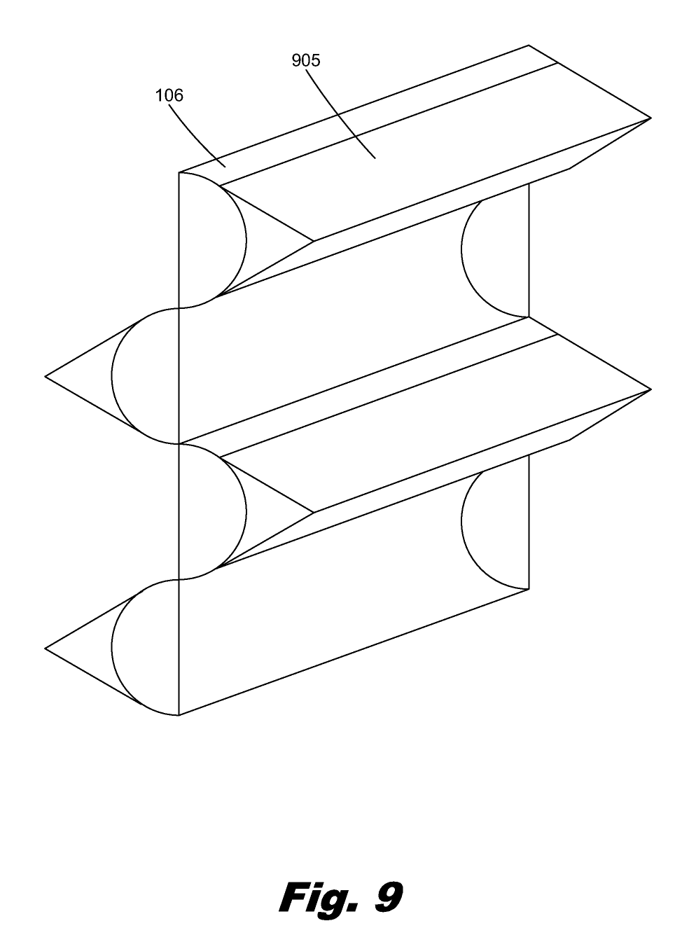

Turning now to FIG. 9, an axonometric side view of a number of vanes (106) according to one example of the principles described herein is shown. In this example, a triangular prism shape (905) has been coupled to the convex side of the individual vanes (106). Coupling the triangular prism shapes (905) to the convex side of the individual vanes (106) may further help produce power from the flow of fluid. Because the convex sides of the vanes (106) lead into the flow of fluid, the triangular prism shapes (905) allow the fluid to flow more easily over the vanes thereby decreasing the drag on the vanes (106).

The specification and figures describe the fluid turbine. The fluid turbine comprises; an inner shaft comprising a first number of vanes coupled thereto, the concave surface being defined as the gathering surface, the first number of vanes forming a number of rows of vanes; and an outer shaft comprising a second number of vanes coupled thereto, the concave surface being defined as the gathering surface, the second number of vanes forming a number of rows of vanes. Adjacent rows of the fluid turbine alternate between a first number of vanes and a second number of vanes, in which the first number of vanes rotate axially in a first direction, and the second number of vanes rotate axially in a second direction.

This fluid turbine having all the advantages of a vertical axis fluid turbine, also has the increased efficiency using the drag force of a non-gathering surface of a particular vane to funnel fluid flow into the gathering surface of an adjacent vane, thereby greatly increasing the amount and speed of fluid entering the gathering vane. The increased amount of fluid and speed increase the torque produced by the fluid turbine.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A fluid turbine, comprising:
an inner shaft comprising a first number of concave vanes coupled thereto; the first number of concave vanes forming a number of rows of vanes, and
an outer shaft, coaxial to the inner shaft, comprising a second number of concave vanes coupled thereto; the second number of concave vanes forming a number of rows of vanes;
in which adjacent rows of the turbine alternate between the first number of vanes and the second number of vanes;
in which the first number of vanes rotate axially in a first direction;
in which the second number of vanes rotate axially in a second direction; and
in which the concave surface of a vane is defines a fluid gathering surface.

2. The fluid turbine of claim 1, in which the fluid gathering surfaces of the first and second number of vanes are facing opposite directions.

3. The fluid turbine of claim 1, in which the first and second number of vanes are oriented such that the fluid gathering surface of each vane creates a 90 degree angle with respect to a direction of fluid flow.

4. The fluid turbine of claim 1, in which said first and second number of vanes are oriented such that the gathering surface of each vane creates an acute angle with respect to a direction of fluid flow.

5. The fluid turbine of claim 1, further comprising:
a number of horizontal supports being coupled at a first end along at least one surface of each vane and being coupled at a second end to the shaft corresponding to the particular vane.

6. The fluid turbine of claim 5, in which the horizontal supports comprise an angled bend at a point along their length.

7. The fluid turbine of claim 1, further comprising:
a number of vane braces coupled at one end to an edge of a vane and coupled at the other end to a corresponding edge of an adjacent vane of the same row.

8. The fluid turbine of claim 1, further comprising:
any number of vane dividers positioned vertically within the fluid gathering surface of a vane.

9. The fluid turbine of claim 1, further comprising:
a number of angled support members coupled at one end to a corner of the fluid gathering surface of the vane, and coupled at the other end to the opposite corner of the fluid gathering surface of the vane.

10. The fluid turbine of claim 9, in which the angled support member is coupled at one end to a corner of the gathering surface of the vane and coupled at the other end to the opposing junction of a vane divider and a vane.

11. The fluid turbine of claim 1, further comprising:
a truss assembly attached at either end to alternating rows of vanes, comprising:
a leading edge support;
a trailing edge support; and
a number of support ties;
in which the support ties connect the leading edge support to the trailing edge support; and
in which the row of vanes located between the alternating rows of vanes is offset from those rows of vanes connected by the truss assembly.

12. The fluid turbine of claim 1, in which any of the second number of vanes is coupled to the outer shaft through a coupling sleeve which is external to and coaxial with the inner shaft;
in which the coupling sleeve is coupled to the inner shaft using bearings that permit the coupling sleeve and the inner shaft to rotate independently and counter to one another.

13. The fluid turbine of claim 12, in which the second number of vanes is coupled to the coupling sleeve through a connecting hub and in which the connecting hub is coupled to the outer shaft.

14. The fluid turbine of claim 1, further comprising:
quarter-sphere structures attached to at least one end of a vane.

15. A fluid turbine, comprising:
a number of shafts, in which each shaft comprises a number of vanes coupled thereto; the number of vanes forming a number of rows of vanes;
in which each shaft rotates axially and independently of one another; and
in which alternating rows are coupled together.

16. A fluid turbine system, said system comprising:
a fluid turbine, said turbine comprising:
a number of shafts comprising a number of concave vanes coupled thereto;
in which the number of concave vanes form a number of rows of vanes, and
in which the shafts are coaxial to one another;
in which adjacent rows of vanes rotate independently of one another; and
in which the concave surface of a vane is defines a fluid gathering surface;
an electric power generator; and
a support framework.

17. The system of claim 16 in which the electric power generator comprises:
a number of flywheels coupled to the shafts of the fluid turbine;
a connecting shaft coupled to and positioned between the flywheels;
any number of gears coupled to the connecting shaft; and
a generator coupled to the connecting shafts.

18. The system of claim 16, in which the electric power generator comprises a direct drive system.

19. The system of claim 16 in which the support structure further comprises:
bearings that permit the shafts to rotate while maintaining the support framework stationary.

20. The system of claim 16, further comprising an electric circuit gate diode in which the voltage or current produced by the fluid turbine system is compared to a previous and respective voltage or current and in which the electric circuit gate diode increases or decreases a load placed on the turbine based on the difference between the voltage or current and the previous voltage or current.
